(19) United States
(12) Patent Application Publication
(10) Pub. No.: US 2026/0257903 A1
(43) Pub. Date: Sep. 3, 2026

(54) CLAMPING TOOL FOR MANWAY COVER AND RELATED METHODS

(71) Applicant: Eyler Design Solutions, LLC, Mont Belvieu, TX (US)

(72) Inventor: Robert L. Eyler, JR., Mont Belvieu, TX (US)

(21) Appl. No.: 19/553,471

(22) Filed: Mar. 2, 2026

Related U.S. Application Data
(63) Continuation-in-part of application No. 18/793,350, filed on Aug. 2, 2024.

(51) Int. Cl. B66F 19/00

(52) U.S. Cl. CPC B66F 19/005

(57) ABSTRACT

A clamping tool for use with manway covers may be selectively attached to a manway to permit the manway cover to be separated from its opposing manway flange without having to completely disassociate such manway cover with its corresponding manway. One possible arrangement makes use of at least two clamps, a manway cover clamp and a manway flange clamp, each of the clamps having portions which can be inserted between opposing portions of the manway cover and the manway flange. The clamping tool maintains the relative alignment of the manway cover and the manway flange, yet permits the manway to be selectively opened by separating the manway cover from such manway flange, or closed after such opening.

### FIELD

The present disclosure relates generally to manway covers for access to enclosed spaces, such as tanks, conduits, storage areas, heat exchange air tubes, and the like. The disclosure, more particularly, relates to a tool to assist when such manway covers are too heavy to be handled by an unaided individual.

### BACKGROUND

Manway covers are typically large, heavy, metal plates that are bolted to an opening. Manway covers may include any heavy covers or closures used in a wide range of applications, including pressure vessels, vacuum vessels, atmospheric vessels, heat exchangers, heat exchanger channel covers, heat exchanger channels, heat exchanger bonnets, heat exchanger shell covers, dished heads, domed heads, half covers such as on divided water box heat exchangers, chiller condensers, chiller heat exchangers, chiller coolers, inspection ports, or any type of blanking plate. In terms of dimensions, such manway covers may or may not be sized to allow passage of a man. The most common are circularly-shaped and mate to a flange by way of a plurality of bolts evenly spaced around the periphery of the opening. However, it should be understood that the heavy covers may be any shape.

The defined manway covers typically provide access to enclosed spaces such as tanks, conduits, storage areas, transfer tubes, pressure vessels, vacuum vessels, atmospheric vessels, heat exchangers, heat exchanger channel covers, heat exchanger channels, heat exchanger bonnets, and the like. These types of covers are typically found in power plants, co-generation power plants, steam generation plants, chemical plants, petrochemical plants, refineries, pharmaceutical plants, air separation plants, beverage plants, food processing plants, heating and cooling facilities, buildings with central heating and cooling systems, buildings with chiller cooling systems, water treatment plants, waste management plants, dairies, tank farms, gas storage facilities, liquid natural gas storage facilities, manufacturing facilities and or any facility that has tanks, vessels, piping, heat exchangers, chillers, boilers, turbines and/or equipment of similar nature.

Routine servicing and inspection requirements as well as other operating conditions necessitate periodic separation of such manway covers from the associated manway, including removal of these covers from a manway flange to which it is secured. In view of the typical configurations of manways and manway covers, their location, weight, or other access constraints, it is not a simple task to separate such manway covers from the manway or manway flange, such separation including removal of the cover for access to the manway otherwise covered. Likewise, re-attaching or re-installing such covers faces similar challenges.

Current systems and devices associated with separating (or removing) manway covers from manways and their associated manway flanges generally suffer from various drawbacks and disadvantages, which would be advantageous to address.

### SUMMARY

This disclosure relates to clamping tools for use in handling components of a manway, such as a manway cover and a manway flange, as well as associated methods for using one or more components of the clamping tool. The clamping tool may be a multi-component system or isolated components useful for certain sub-tasks associated with the handling of manway components, and associated methods for using the tools are similarly varied, as disclosed herein.

In one suitable implementation, the clamping tool is configured for use in lifting a manway cover from an associated manway flange of a vertically oriented manway. A plurality of manway flange clamps are secured about the circumference of the manway flange and a lift assembly is interconnected to the manway flange clamps by a frame. The lift assembly has multiple fingers which function to secure the lift assembly relative to the manway flange being handled by the clamping tool.

In another potential implementation of the various possible configurations of clamping tools, a method involving the clamping tool involves the use of at least one manway flange clamp which will be removably secured to a corresponding manway flange, and at least one manway cover clamp which will be removably secured to a corresponding manway cover. The method involves inserting multiple clamp fasteners through manway flange holes without altering the predetermined size of the manway flange holes, in order to secure the manway flange clamp to the manway flange. The manway cover clamp is likewise secured by inserting a second set of clamp fasteners through holes in the manway cover, again, without altering the predetermined size of the manway cover holes.

In another suitable implementation, the clamping tool is in the form of a clamp which itself can be removably secured to selected manway components having holes therethrough. Such components can include the manway cover just as equally as the manway flange, as those terms are used herein, or any manway components normally secured to each other by receiving fasteners through holes bored through the components, such as blind flanges, or any number of associated bolted flanged components. In other words, the clamp according to certain embodiments may equally well be used on the manway cover or so called “blind flange,” as well as the manway flange, which in this disclosure refers to the flange surrounding the opening of the manway. Still further uses with still further components related or even unrelated to a manway are contemplated.

In further implementations, the clamp fasteners which are sized to engage holes in the manway cover or the manway flange are adjustably mounted, that is, the spacing between adjacent clamp fasteners may be adjusted so that the clamp may be secured to a range of different flange or cover sizes and different radial spacing between adjacent holes.

In still another possible implementation, adjustment of the clamp fasteners may be accomplished by means of jack blocks which will be adjusted to selectively move one or more clamp fasteners relative to each other.

In still other implementations, a linkage may be provided between multiple clamp fasteners. A lever arm attached to such linkage can be manipulated to change spacing between the clamp fasteners after insertion in corresponding holes, in this way generating an engagement force between the clamp fasteners and the holes.

In still further implementations, the clamp may be a simplified tool that has a single clamp fastener and a clip with a rotatable swing arm or jaw for readily attaching the single clamp fastener to a blind flange or manway cover. In these implementations, the rotatable jaw or swing arm remains secured to the flange or manway cover regardless of its orientation in relation to gravity. In other words, the single clamp fastener implementation may be readily attached and thereafter provide a means for attaching a cable or other hoist in a secure manner while such manway cover or flange is being lifted from the ground or otherwise incurring angles in relation to the clamping tool or the hoist.

Still further, a portable or simplified clamping tool may include multiple clamp fasteners which are readily attachable and detachable. Such simplified clamping tool may have one of the jaws of the clamp in the form of a swing arm. The swing arm has a pivot point at one end and the other end rotates through an arc or angle so that the swing arm can be engaged with an opposing surface of the manway cover or flange and may be rotated or swung radially outwardly to be disengaged therefrom.

In still further implementations, the clamping tool may include connectors to be secured to the arm of a davit assembly on the one hand, such as when being secured to the removable manway cover, and the connector may likewise be suitably configured to be secured to a portion of the manway flange at the base of such davit assembly.

In still further variations, instead of a swing arm as one of the jaws of the clamp, a plurality of rotatable fingers may be provided to be rotated into and out of engagement over the edge of the manway cover or manway flange.

The various configurations of clamps in this disclosure, as well as corresponding davit arms, frames, and connectors to the clamps, may be kitted together so that different size flanges in different orientations with different handling requirements may be addressed by selectively using one or more clamps of the kit, in association with one or more connectors and frame components either present in situ or brought to the site with the kit. Advantageously, the components of the clamps and various features are light enough to be suitably kitted or even independently would remain portable to job sites or other operational environments, in accordance with certain possible implementations of this disclosure.

### BRIEF DESCRIPTION OF THE DRAWINGS

A more complete understanding of the present disclosure, and the attendant advantages and features thereof, will be more readily understood by reference to the following detailed description, when considered in conjunction with the accompanying drawings, wherein:

FIG. 1 is an isometric view of one possible implementation of a clamping tool for a manway cover according to the present disclosure;

FIG. 2 is an exploded, isometric view of the implementation of the clamping tool of FIG. 1;

FIG. 3 is a rear, elevational view of the implementation of the clamping tool of FIGS. 1-2;

FIG. 4 is a top, plan view of the implementation of the clamping tool of FIGS. 1-3;

FIG. 5A is a partial, isometric view of certain components of the clamping tool of FIGS. 1-4 taken along line 5A-5A of FIG. 1;

FIG. 5B is another partial, isometric view of certain components of the clamping tool shown in FIGS. 1-5A, taken along line 5B-5B of FIG. 1;

FIG. 6 is a partial, isometric view of another possible implementation of a clamping tool for a manway cover according to the present disclosure;

FIG. 7 is an isometric view of another possible implementation of a clamping tool according to the present disclosure;

FIG. 8 is an isometric view of another possible implementation of a clamping tool according to the present disclosure;

FIG. 9 is an isometric view of still another possible implementation of a clamping tool in one potential operational environment;

FIG. 10 is a front elevational view of still a further implementation of a clamping tool according to the disclosure herein;

FIG. 11 is a rear elevational view of the clamping tool implementation shown in FIG. 10

FIG. 12 is an exploded, perspective view of the clamping tool implementation shown in FIGS. 10, 11;

FIG. 13 is a perspective view from one angle of still another possible implementation of a clamping tool according to the present disclosure;

FIG. 14 is another perspective view of the clamping tool implementation of FIG. 13, from another angle relative thereto;

FIG. 15A is a perspective view of a jack block according to certain implementations of the clamping tool of the present disclosure;

FIG. 15B is an exploded perspective view of the jack block of FIG. 15A;

FIG. 16 is a perspective view of still another possible implementation of a clamping tool according to the present disclosure, shown in one potential operational environment handling a manway cover or blind flange; and

FIG. 17 is a perspective view of still a further possible implementation of a clamping tool according to the present disclosure.

### DETAILED DESCRIPTION

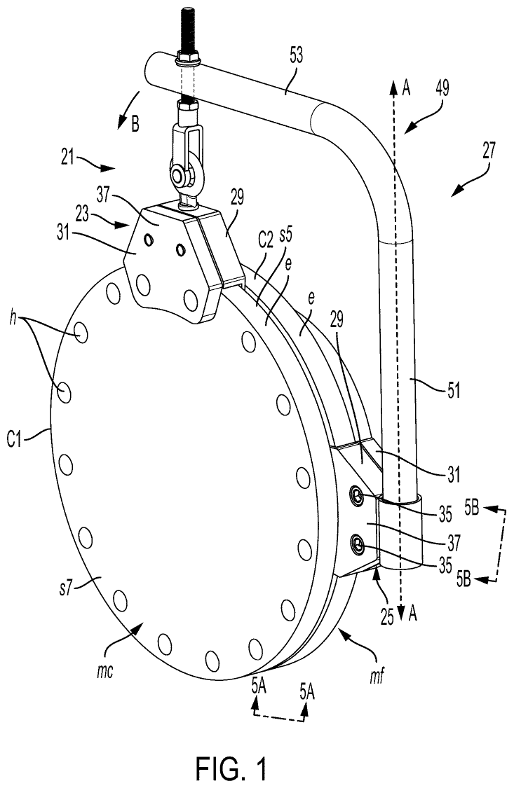

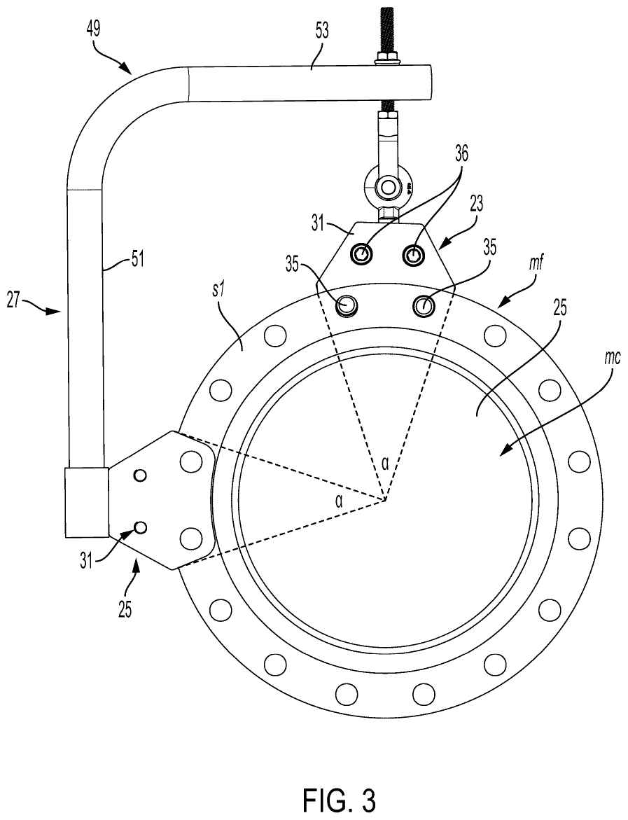

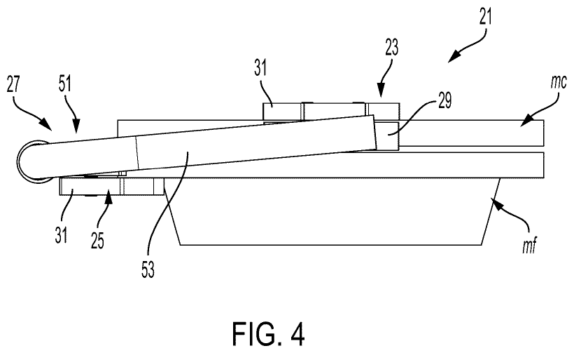

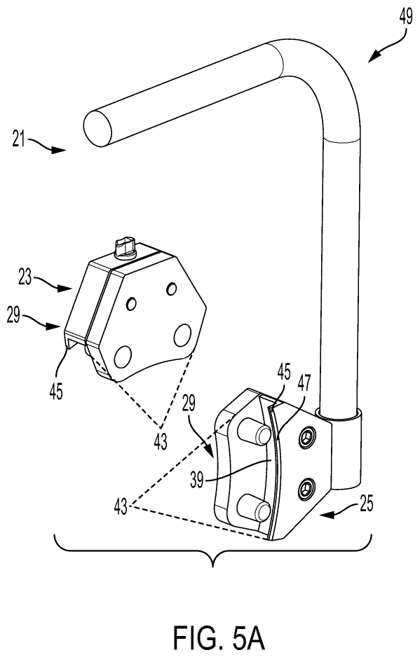

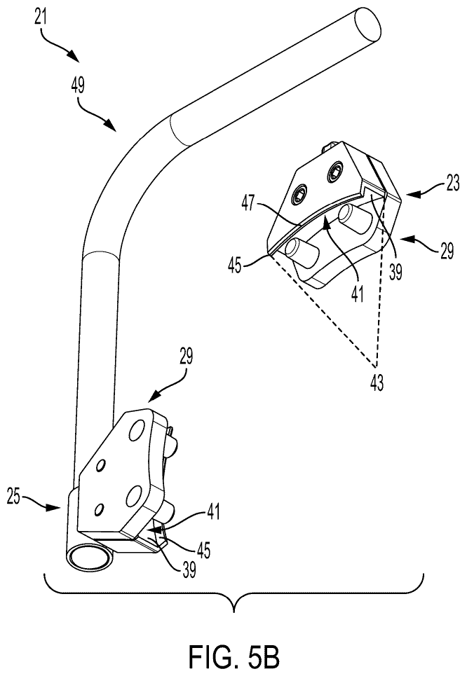

Referring now to the drawings and, in particular to FIGS. 1-4, 5A, and 5B, a clamping tool 21 has been suitably connected to a manway mw to help separate a manway cover mc from an associated manway flange mf. Clamping tool 21 has various components and features, to be detailed herein, to permit separation of manway cover mc so as to open manway mw for any suitable purpose, such as gaining access to manway mw.

The various components and features of clamping tool 21 have been configured to work or otherwise interact with certain parts and portions of manway mw, the associated manway flange mf and manway cover mc, preferably with little to no modification of the existing manway and its components. So, for example, in the illustrated implementation of FIGS. 1-4, 5A, 5B, clamping tool 21 includes two clamps, one of which is a cover clamp 23, removably securable to the manway cover mc, whereas the other clamp is a manway flange clamp 25, which is removably securable to manway flange mf. Each of the clamps 23, 25 have respective inner and outer jaws 29, 31.

Inner jaws 29 are among the features of clamping tool 21 which assist in making separation of manway cover mc from manway flange mf relatively straightforward. In the illustration implementation, inner jaw 29 of cover clamp 23 is able to be removably secured to inward surface s5 of manway cover mc, whereas inner jaw 29 of manway flange clamp 25, for its part, is removably securable to a front flange surface s3 of manway flange mf. As such, inner jaws 29 of each of the clamps 23, 25 are able to be positioned between opposing portions of manway flange mf and manway cover mc during associated opening procedures for manway mw.

Outer jaws 31 of each of clamps 23, 25, are located opposite inner jaws 29 and are removably securable, respectively, to outward surface s7 of manway cover mc and rear flange surface s1 of manway flange mf. Clamps 23, 25 therefore retain manway cover mc and manway flange mf between their respective clamp jaws, that is, inner and outer jaws 29, 31, and thus retain manway cover mc in operative proximity to, or in a nearby position relative to, manway flange mf, to permit selective opening, closing, or other partial separation of the two.

Although many variations and implementations are possible, in the clamping tool 21 illustrated in FIGS. 1-4, 5A and 5B, a frame 27 is secured between the two clamps 23, 25, so as to permit selective opening and closing of manway mw, by rotating manway cover mc away from manway flange mf about an adjacent axis. With regard to frame 27, portions of frame 27 are connected to the clamps 23, 25, so that such frame portions are movable relative to each other. Frame 27 may comprise a davit 49, in which such davit 49 has a mast member 51 and a davit arm 53 extending orthogonally relative to mast member 51. Mast member 51 is rotatable about an axis of rotation A, which axis is adjacent manway mw. Arm 53, in turn, extends orthogonally and adjacent to manway mw to swing out therefrom when the mast member 51 is suitably rotated about axis A. Rotation of mast member 51 and its securement relative to manway flange clamp 25 is such that the inner and outer jaws 29, 31 of cover clamp 23 open relative to each other from the position shown in FIG. 1, when mast member 51 is rotated about axis A in the direction shown by arrow B.

The shapes and configurations of clamps 23, 25, frame 27, and other components of clamping tool 21 may be varied so as to be connectable to manway flanges and manway covers of any number of configurations. For example, components of clamping tool 21 may be altered for manways having circumferences of any shape or size. So the term circumference, as used herein, applies equally to non-circular or non-ovoid openings, such as a quadrilateral, square, or other polygons, as well as to ovoid or circular circumferences.

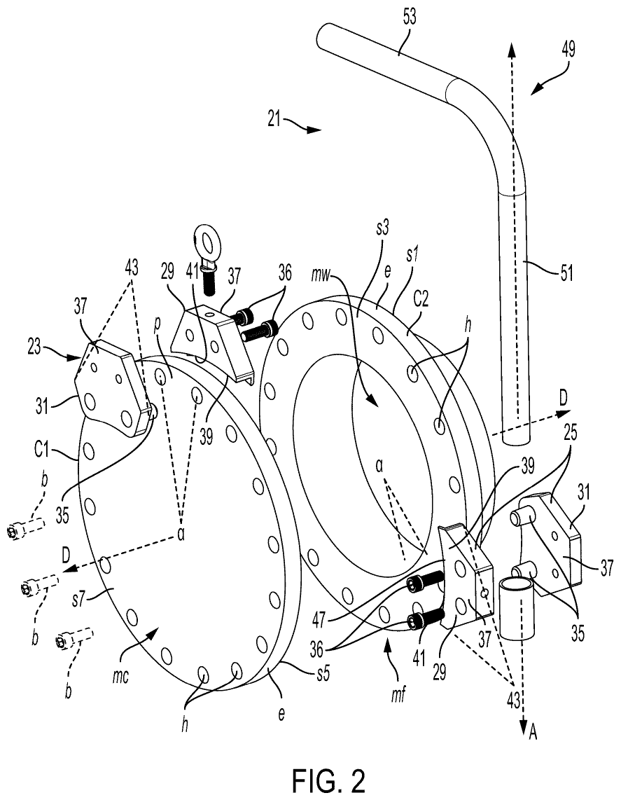

Similarly, manway covers may be secured to corresponding manway flanges not only by removable bolts, but also by any number of other instrumentalities. In the illustrated implementations shown in FIGS. 1-4, 5A and 5B, manway cover mc and manway flange mf have respective circumferences C1, C2, which are ovoid, in this case, substantially circular. When manway mw is closed, that is, in the closed state, manway flange mf and manway cover mc are secured to each other by a plurality of manway cover fasteners b (which, although, removed for clarity, have been shown in the form of phantom lines in FIG. 2). A plurality of manway cover fasteners b are received through corresponding, circumferentially spaced holes h of predetermined size, holes h passing through both manway flange mf and manway cover mc.

In one possible implementation, clamping tool 21 is configured to be suitable for temporary or limited duration attachment to the manway, such as for accomplishing a short duration access or procedure with the associated manway. In such configuration, the components and features described herein for clamping tool 21 permit relatively quick and efficient installation on and removal from the associated manway. In one suitable installation operation, some or all of manway cover fasteners b may be loosened or removed, such that a gap can be created between the opposing portions of inward cover surface s5 and front flange surface s3. Inner jaws 29 may then be inserted in such gap. Thereafter, clamps 23, 25 may be removably secured to manway cover mc and manway flange mf, respectively.

In the implementation of FIGS. 1-4, 5A, and 5B, there are two of the clamp fasteners 35 in the form of male, protruding pins from outer jaws 31 of clamps 23, 25 extending substantially through corresponding holes h in manway cover mc and manway flange mf. There can be fewer or greater numbers of clamp fasteners 35, depending on the size and configuration of clamps 23, 25. In the illustrated implementation, clamp fasteners 35 are sized or otherwise configured to engage some of the holes h of predetermined size formed in manway cover mc or manway flange mf, as the case may be. In such implementations, there is no need to alter the diameter, size, threads, or other configuration of holes h which have been formed of predetermined size for the associated manway mw. Clamp fasteners 35 may be of any suitable form, including unthreaded pins as shown in FIGS. 1-4, 5A and 5B, but also may include threaded pins, threadably received bolts, and threaded through-bolt-and-nut assemblies.

Clamp fasteners 35, such as the protruding pins of the illustrated implementations, may be formed integrally with outer jaws, welded, soldered or otherwise permanently connected to portions of outer jaws 31 opposable to the manway cover mc or the manway flange mf, or releasably connected thereto, such as being threadably received, press-fit, or otherwise retained in apertures formed in outer jaws 31 (that is, female connections on outer jaws 31) or engaged around studs extending from outer jaws 31 (that is, male connections on outer jaws 31).

Clamp fasteners 35 are sized or configured to form a snug or interference fit with holes h with which they are engaged, so as to help resist shear or other forces caused by gravity acting on manway cover mc when it is separated from manway flange mf. As such, when pins are used as clamp fasteners 35, as shown, such pins are described as “hole size,” meaning they correspond to the diameter of holes h. Typical diameters for holes h include 1 ¼ inch, 1 ⅜ inch, and 1 ½ inch. The cylindrical or outer surfaces of fasteners 35 which may engage opposing surfaces of holes h may include knurls, textured, or roughened surfaces, or fine threads to help with engagement, especially in the event the holes h include rust, paint, or other contaminants to be overcome for engagement of clamp fasteners 35.

Alternately, taper tap bolts may be used as clamp fasteners 35 themselves or may be run into holes h to clean or tap them, such use being in conjunction with engagement by clamp fasteners 35 when in the form of the aforementioned pins. Such taper tap bolts include longitudinally extending slots cut like a tap, with a taper similar to a bottoming tap. Chamfer would be selected to accomplish recommended thread engagement of a threaded clamp fastener 35 or equivalent.

Still further variations to clamp fasteners 35 are possible, such as an expansion, eccentric, or anchor type design.

As further installation steps, clamps 23, 25 have their respective inner and outer jaws 29, 31, selectively and temporarily secured to each other in a clamping arrangement around manway cover mc manway flange mf, respectively, by additional fasteners 36, such as threaded bolts, extending between partially or fully threaded apertures formed in inner and outer jaws 29, 31. Fasteners 36 may assume any number of alternate forms suitable for clamping the inner and outer jaws around the manway cover mc or manway flange mf. Clamping tool 21 may be uninstalled or removed from manway mw, and the manway may be reclosed, by reversing the foregoing installation steps.

Given the size and weight generally associated with manway covers, clamping tool 21 may include additional components and features to retain manway cover mc in position relative to manway flange mf when manway cover mc is sought to be separated therefrom. In the illustrated implementation, inner jaws 29 of clamps 23, 25 include transverse, jaw surfaces 39 which are configured to oppose and engage portions of circumferential edges e on corresponding circumferences C1, C2 of manway cover mc and manway flange mf, respectively. In the case of circular or ovoid circumferences C2, C2, as in the illustrated implementation, transverse, jaw surfaces 39 include arcuate jaw portions 41 which are matched to correspond to arcuate portions α on circumferential edges e. As such, arcuate jaw portions 41 extend over arc-lengths of the circumferential edges e and thereby oppose arcuate portions α along such arc-lengths. Such opposing arcuate surfaces, in turn, support alignment of manway cover mc relative to a central axis D of manway mw.

Inner jaws 29, in the illustrated implementation, also include respective lips 45 which extend over corresponding lip arc-lengths. Lips 45 extend radially inwardly between the opposing surfaces of manway cover mc and manway flange mf when clamps 23, 25 are secured thereto. When so positioned, lips 45 have engaging portions configured to extend and engage inward cover surface s5 of manway cover mc and front flange surface s3 of manway flange mf, respectively. Such engagement, in turn, may resist certain forces acting on clamping 21 when attached to manway mw. Such forces, for example, may arise in connection with relative movement of the manway cover mc relative to manway flange mf, and may include bending moments acting on clamping tool 21.

Inner and outer jaws 29, 31 include respective base portions 37 which are securable by means of the fasteners 36 discussed previously. Base portions 37 are configured and sized to be secured relative to circumferences C1, C2 of manway cover and manway flange, respectively, at respective locations radially outwardly from such circumferences.

The number of cover clamps 23 or manway flange clamps 25 can be varied depending on the application, as can the radial location of such clamps 23, 25 about circumferences C1, C2 of manway cover mc and manway flange mf. In the illustrated implementation, for example, manway flange clamp 25 is located so as to permit securement at a 3 o'clock position on manway flange mf, whereas cover clamp 23 is secured to manway cover mc at a 12 o'clock position. As such, davit 49 and its components extend upwardly from a mast base location on manway flange clamp 25, then orthogonally adjacent the manway to cover clamp 23, which cover clamp is suitably suspended from a portion of davit arm 53.

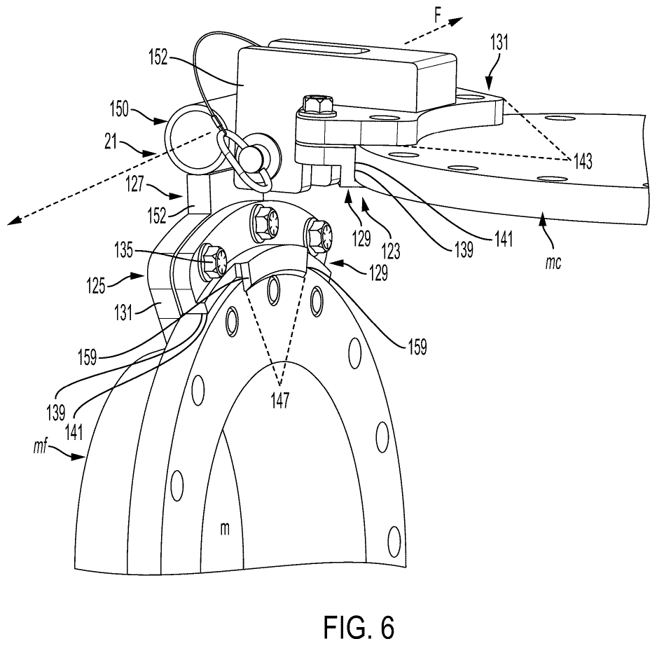

Other variations are within the scope of the present disclosure. For example, referring now to FIG. 6, another implementation of a clamping tool is shown with reference numerals in the 100 series corresponding to similar components in clamping tool 21. As such, clamping tool 121 makes use of three of the clamp fasteners 135 located and arcuately spaced to engage three of the predetermined sized holes h. Unlike clamping tool 21, clamps 123, 125 of clamping tool 121 are connected to a hub 150 by a pair of arms 152. In addition, clamping tool 121 has each of its two clamps 123, 125 at substantially the same radial position on the manway mw. In such configuration, the two clamps 123, 125 substantially oppose each other when in the closed position, and rotatably separate from each other when manway cover mc is separated from manway flange mf by rotation about hub 150.

Hub 150 defines a single axis of rotation F about which clamps 123, 125 rotate relative to each other, although two or more parallel axes may likewise be suitable. In the implementation of FIG. 6, although clamps 123, 125 oppose each other, lips 145 of respective, inner jaws 129 have been configured to have their arc-lengths positioned to be arcuately offset relative to each other. In this way, lips 145 engage the opposing portions of manway cover mc and manway flange mf at different radially spaced locations when the clamping tool 121 is attached to manway mw. This permits lips 145 not only to engage corresponding inner surfaces of manway flange mf and manway cover mc, but also prevents lips 145 from interfering with each other when, after installation of clamping tool 21, manway cover mc is closed over or substantially adjacent to manway flange mf.

As yet another feature, lips 145 may be sized so that their engaging surfaces on manway flange mf and manway cover mc have respective side edges 159. Such side edges 159 of adjacent lips 145 may be arcuately located to abut each other when manway cover mc is closed. In this manner, such abutting side edges 159 may provide some additional support of the position of manway cover mc relative to manway flange mf when closed.

In one suitable implementation, lips 45, 145 extends over opposing portions of the manway cover and manway flange by ¼″.

Clamping tool 21, 121 may have its dimensions adapted and configured so as to correspond to certain predetermined, manway diameters generally encountered in applications, facilities, or industries where such manways may be present, such as diameters of 16, 18, 20, and 24 inches. In those implementations where transverse jaw surfaces 39, 139 are formed with arcuate surfaces, clamping tool according to this disclosure may be in the form of a kit suitable for manway flanges and manway covers having the foregoing or still other predetermined diameters. Such predetermined diameters have corresponding arcuate, circumferential edges, as discussed previously. As such, clamping tool 21, 121, when in the form of a kit, would comprise four pairs of clamps 21, 23 or 121, 123, each of the pairs configured to be securable to a corresponding one of the aforementioned diameters. Inner jaws 29, 129 of the clamps would comprise a set of transverse, arcuate jaw portions having associated arc-lengths with radii corresponding to the various predetermined diameters, thereby permitting such arcuate jaw portions to engage a corresponding arcuate circumferential edge of corresponding manway covers and manway flanges of the various predetermined diameters for which the clamping tool set has been configured.

Still further variations in terms of the number of clamps the locations thereof are within the scope of this disclosure. For example, it may be desirable to have clamp tool 21 make use of one or more manway flange clamps 25 without cover clamps 23. Instead, a hoist, davit, or other frame member may interconnect the flange clamps 25 to the manway cover mc.

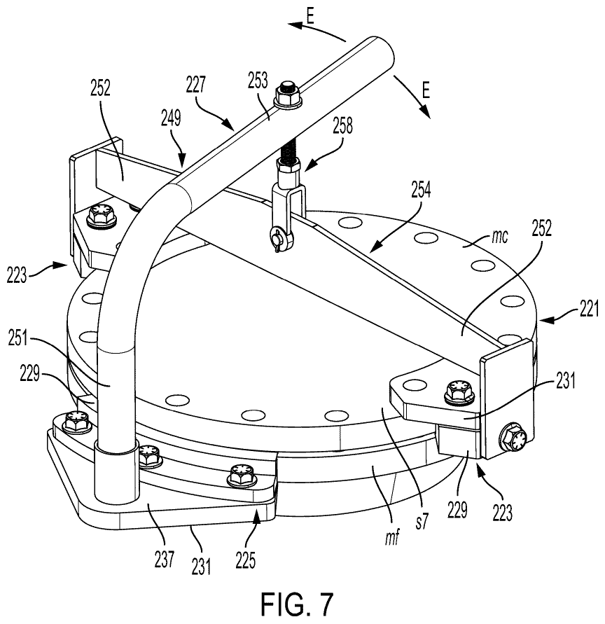

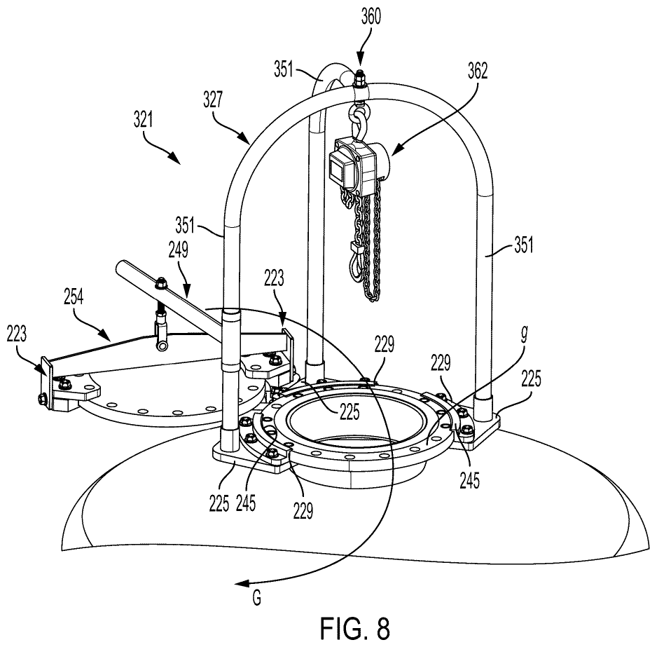

In still further implementations, such as those shown in FIGS. 7 and 8, clamping tools of the present disclosure may be installed on manway flanges and covers of vessels, buildings, or environments in which manways are orientated non-horizontally, such as vertically or substantially vertically, relative to a plane of reference. In such environments or applications, the manway flanges are horizontal or substantially horizontal, as are their associated manway covers. FIG. 7 shows one exemplary implementation, in which reference numerals of elements similar to those of previous implementations are identified with the same numeral, but in the 200-299 numeric range.

As such, a clamping tool 221 makes use of a pair of manway cover clamps 223 which are removably securable to manway cover mc at spaced, circumferential locations, such as at 180 degrees from each other. Cover clamps 223 are secured to respective arms 252 of a lift assembly 254. Lift assembly 254 has a midsection 256 between arms 252, which midsection 256, in turn, is secured by a suitable, length-adjustable connecting rod, bolt or similar interconnector 258, to a rotatable portion of a frame 227. Frame 227 is positionable and securable in operative proximity to the vertical manway.

Frame 227 may assume any configuration suitable for the non-horizontal (i.e., vertical) manway, including the form of a davit 249. Similar to the implementations of FIGS. 1-4, and 5A and 5B, davit 249 has a davit arm 253 extending orthogonally to a mast member 251. Davit 249 has sleeves or other rotatable interconnections relative to davit arm 253 to selectively swing davit arm 253 about a suitable axis, such as a longitudinal axis of mast member 251.

In the illustrated implementation of FIG. 7, davit arm 253 extends from a location proximate to the circumference of the vertical manway, radially inwardly across all or a portion of outward cover surface s7. Mast member 251 is rotatably connected relative to manway flange mf through a suitable base portion 237 of manway flange clamp 225. Cover clamps 223 and manway flange clamp 225 include respective, inner jaws 229 and outer jaws 231, with portions of inner jaws 229 insertable between opposing portions of manway cover mc and manway flange mf, as discussed previously with respect to implementations of FIGS. 1-4, 5A, 5B, and 6.

By virtue of the foregoing configuration, the adjustable interconnector 258 may be used to raise manway cover mc to separate it from underlying manway flange mf by a suitable amount, so that there is clearance between the inner jaw 229 of the cover clamp 223 and the inner jaw 229 of manway flange clamp 225, respectively. Once sufficient clearance has been formed, davit arm 253 may be rotated about mast member 251, in either of the directions shown by arrow E, to swivel or otherwise displace manway cover mc from its position overlying manway flange mf by a sufficient amount to allow access to the associated manway. In other words, clamping tool 221 is removably attachable to a manway flange and cover oriented in a horizontal plane to facilitate horizontal movement of the manway cover mc to open the corresponding manway.

Lifting assembly 254 of clamping tool 221 may assume a variety of configurations beyond those shown in FIG. 7. For example, although the ends of lifting assembly arms 252 in the illustrated embodiment include outer jaws 231, alternately, such outer jaws 231 may be simplified, integrated, or otherwise dispensed with entirely, by virtue of corresponding features integrated at or connected to the ends of arms 252. For example, at the outer ends of arms 252, instead of outer jaws 231, a T-bar with two pins may simply be added to secure inner jaws 229 to arms 252, such configuration still permitting the vertical raising of manway cover mc by suitable actuation of the length adjustable interconnector 258.

Referring now to FIG. 8, another implementation suitable for use with a vertical manway mw includes clamping tool 321 with frame 327 configured with further functionality. In this implementation, frame 327 not only includes davit 249 interconnecting cover clamps 223 to manway flange clamp 225 to permit raising of manway cover mc and rotation thereof as described previously with reference to FIG. 7; but also frame 327 includes an extraction system 360 removably securable to manway flange mf by suitable manway flange clamps 225 at corresponding base portions of multiple mast members 351.

Manway flange clamps 225 include inner and outer jaws 229, 231, as described previously, which are removably connectable at corresponding arcuate locations to the circumference of manway flange mf. Frame 327 is secured to claims 225 and extends upwardly or vertically relative to vertical manway mw. Frame 327 has a hoist or other suitable attachment mechanism 352 at its apex 360 to connect to a harness or to be otherwise suitably connected to a worker accessing, descending, ascending, or otherwise performing operations inside the manway or otherwise associated with the open manway. In one implementation, frame 327 is configured to provide or assist with safety or other occupational compliance aspects of personnel accessing the vertical manway.

In many applications, as shown by the exemplary implementation of FIG. 8, there is a suitable, resiliently compressible gasket, such as a rubber gasket g, extending around the circumference of the connection between manway flange mf and manway cover mc. The horizontal manways (and vertically oriented manway flanges mf and manway covers mc) of the implementations illustrated in FIGS. 1-4, 5A, 5B, and 6 may likewise have raised flanges or other surface treatments to receive gaskets therebetween.

The installation of the clamping tools disclosed herein, and corresponding operations thereof, are apparent from the foregoing description. With regard to FIGS. 7 and 8, manway flange clamps 225 are suitably installed around the circumference of manway flange mf. Inner jaws 229 extend between opposing surfaces of manway flange mf and manway cover mc. Depending on the application, installation of inner jaws 229 between the opposing surfaces of manway flange mf and manway cover mc may not require loosening of manway cover fasteners b. In such applications, lips 245 of inner jaws 229 may be able to be sufficiently inwardly compress gasket g radially inwardly, so as to permit clamping around manway flange mf. In other applications, with or without gaskets g, it may be more suitable to loosen manway cover fasteners b, as described with reference to implementations of FIGS. 1-4, 5A, 5B, and 6, sufficiently to form a gap to attach clamps 23, 123 and 25, 125.

Similar to the previous implementations, for vertical manways, cover clamps 223, including, at least inner jaws 229 thereof and, optionally, outer jaws 231, are removably secured to manway cover mc, again, with radially inwardly extending lips 245 of inner jaws 229 inserted between opposing surfaces of manway cover mc and manway flange mf. By suitable actuation of the length adjustment interconnector 258, inner jaws 229 of cover claim 123 raise manway cover mc by a sufficient amount to clear opposing portions of inner jaws 229 of the cover clamps 223 and manway flange clamps 225.

In the case of frame 327, mast members 351 have been arcuately spaced to leave a sufficiently large opening, such as an opening extending over at least half the circumference of manway mw, such that davit arm 252 maybe swung in the clockwise direction indicated by arrow G, to open the manway mw. Thereafter, if a person needs to enter the manway, such as entry into a vessel, extraction mechanism 360 is operatively positioned above the now open manway mw and has been suitably secured by means of manway flange clamps 225, to permit hoisting a person into and out of manway mw.

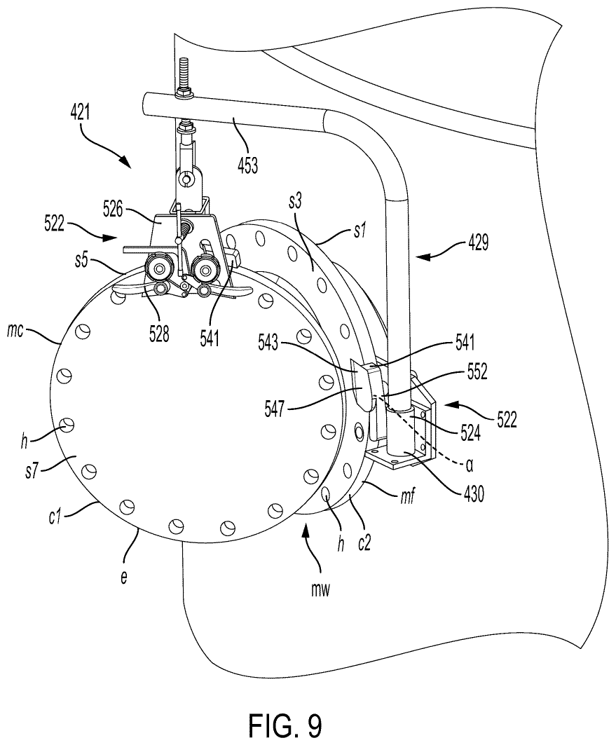

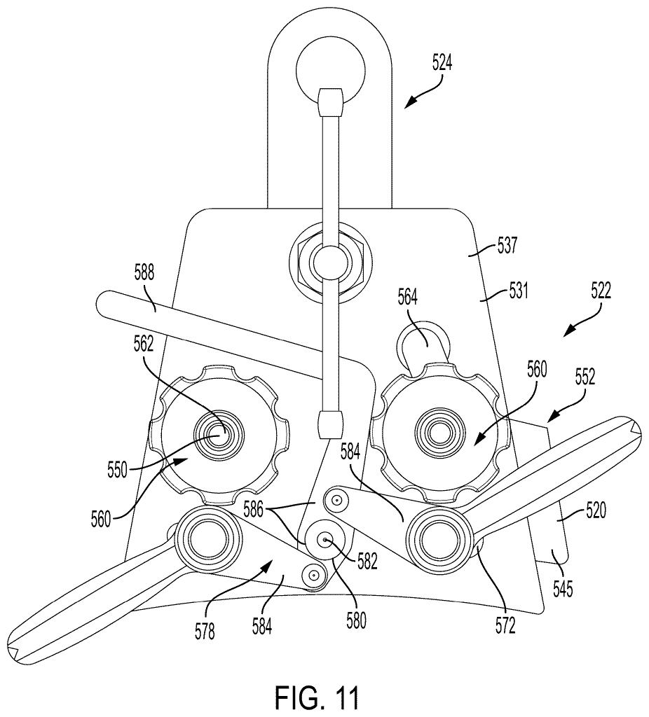

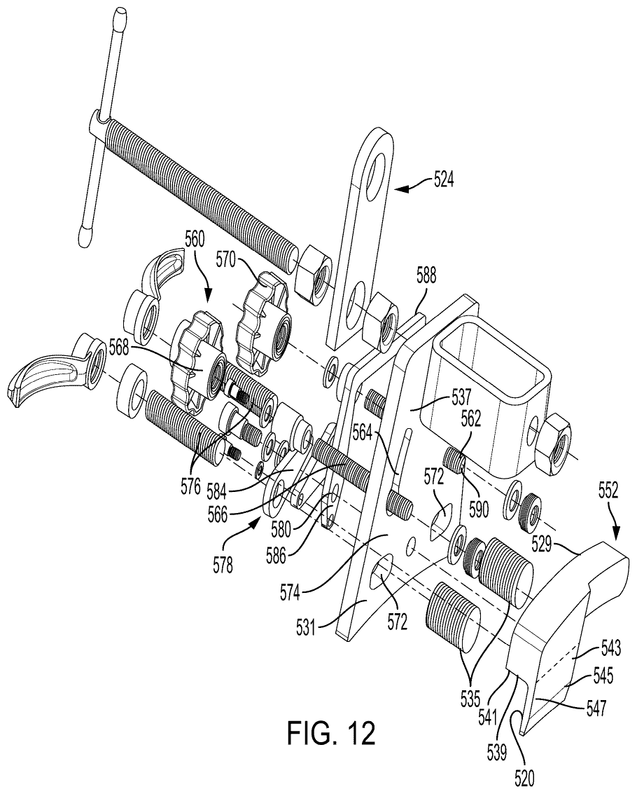

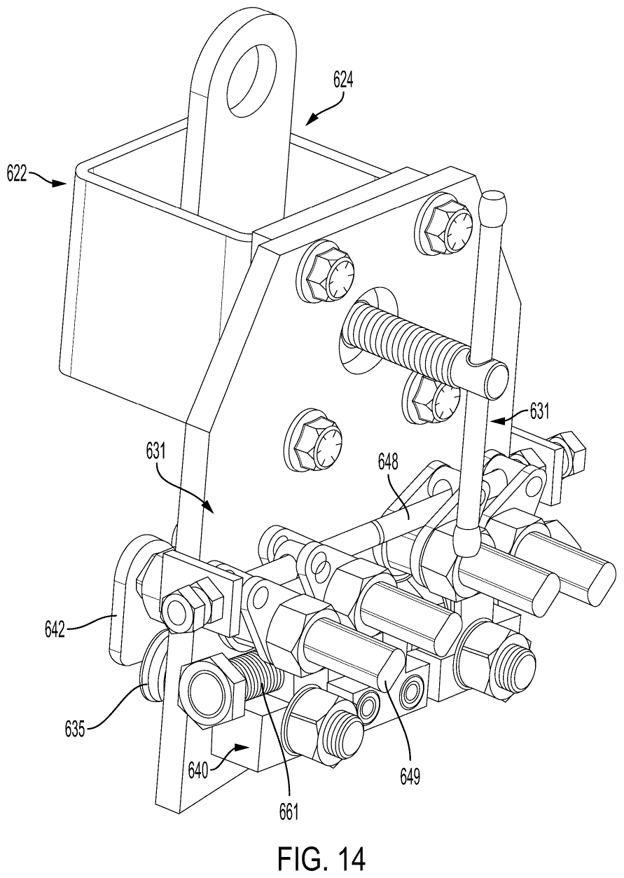

FIGS. 9-17 show still further variations to the clamping tools of this disclosure, which tools or tool components can be combined or used separately, depending on the contemplated operations and applications. Components in the illustrated embodiments of FIGS. 9-17, where appropriate, make use of identical reference numerals or reference numerals with the last two digits corresponding to like or similar components of the previous embodiments.

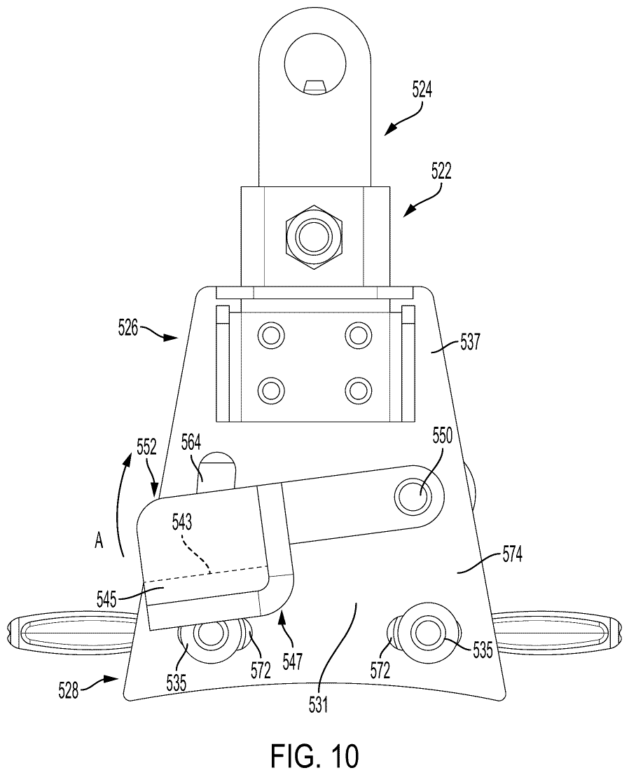

Referring first to FIG. 9, clamping tool 421 is adapted for use in handling operations related to a manway mw similar to the application shown and described in reference to FIGS. 1-5. In this implementation, the clamps 522 have inner jaws 529 in the form of a swing arm 552. Swing arm 552 is pivotable between two positions, the first one in which it is engaging a corresponding one of the opposite surfaces s3 or s5 of the manway flange mf or manway cover mc, and a second position where the swing arm is rotated radially outwardly, in the direction indicated by reference arrow A (FIG. 10), from the first position by a sufficient amount to permit disengagement from the corresponding manway surface. Although two of the clamps 522 are used in the implementation shown in FIG. 9, other variations using only one of the clamps 522 on only one of the manway components are within the scope of this disclosure.

To that end, referring now more particularly to FIGS. 10-12, clamp 522 has proximal and distal portions 526, 528 with proximal portion 526 having a connector 524 disposed thereon. Connector 524 is suitable for connecting the proximal portion 526 of clamp 522 to any number of frames, support members, hoists or other equipment for handling operations. The clamp fasteners 535 are located on distal portion 528 and at least one of its inner and outer jaws 529, 531. As in previous embodiments, clamp fasteners 535 are removably securable in corresponding holes h of the manway components, which normally receive manway cover fasteners b (FIG. 2) during intended operations, but which have been removed or are otherwise absent for contemplated operations. Such holes h are found not only in any number of manway components, such as manway flanges and manway covers (blind flanges), as illustrated in this disclosure, but may also be found on similar structures with heavy components bolted together with a series of spaced fasteners in corresponding holes h. Such additional structures are thus capable of receiving one or more clamp fasteners 535 therethrough in connection with handling operations aided by clamping tools of this disclosure.

Distal portion 528 of clamp 522 can assume various configurations so that it is removably securable to either one of the various planar, opposite surfaces of the manway components, such as surfaces s1, s3, s5, or s7. In the illustrated implementation, two clamp fastener 535 extends from outer jaw 531 toward inner jaw 529, but the reverse may also be implemented.

Jaws 529, 531 are adapted so they can be separated or adjustable as to the spacing between them, so they can receive circumferential edges e of manway components therebetween, and thereby be selectively secured to or removed from the opposite surfaces of the manway components, such as s1/s3, s5/s7 for the two, illustrated manway components mf and mw. As such, clamp fastener 535 is oriented to extend between jaws 529, 531 and is sized to be insertable into a corresponding one of the holes h of the manway components, without alteration of the predetermined size of the hole h. In the illustrated implementation, clamp 522, when secured to the corresponding manway component, has its base portion 537 positioned at a location radially outwardly from the circumferences c1, c2 of the manway component, and the jaws 529, 531 and clamp fastener or fasteners 535 are positioned at locations radially inwardly from the corresponding circumferences.

As in previously disclosed embodiments, clamp fastener 535 may take any number of suitable forms for operative engagement with the holes of the manway component. Such operative engagement includes friction or interference fit produced in any number of ways, such as tight tolerance mating; roughened, scored, eccentric surfaces on clamp fasteners 535; and the like. As used herein, the statement that such engagement does not alter the predetermined size of the hole into which the fastener 535 is received includes whatever abrasion may occur to hole h during insertion of clamp fasteners generally, including clamp fasteners 535, and is meant to convey only that insertion of clamp fasteners nor does it require separate operations of tapping or reaming holes h. Accordingly, clamp fastener 535 may take the form of unthreaded pins, threaded pins, threadably received bolts, eccentric bolts, expandable bolts, threaded through-bolt-and-nut assemblies, and any number of fasteners with chemically or mechanically treated surfaces to promote engagement in holes h.

Clamping tool 521 and its clamp 522, in certain illustrated embodiments, have two of the clamp fasteners 535; however, fewer or still more clamp fasteners are within the scope of the present invention, as contemplated herein.

As in previous embodiments, clamp 522 includes a transverse, jaw surface 539 configured to oppose and engage an opposing portion of the circumferential edge e when the clamp 522 is secured thereto. Again, circumference may be interpreted to include any number of polygonal shapes, including circular or ovoid circumferences which have arcuate portions along corresponding circumferential edges e. As in previous embodiments, transverse jaw surface 539 is in the form of an arcuate jaw portion 541 having a jaw portion arc-length 543 configured to oppose circumferential edge e along a circumferential arc-length α.

As in previous embodiments, one or both of the jaws 529, 531 in clamp 522 has a lip 545 which extends for a corresponding lip arc-length 547, lip 545 extending radially inwardly from circumferential edge e when clamp 522 is secured to such edge. As such, lip 545 presents engaging portions 520 which extend and engage opposing portions of the corresponding one of the surfaces, such as one of surfaces s1, s3, s5, or s7, such engagement occurring over the lip arc-length 547 of the jaw, and such engagement acting to resist bending moment which would be experienced potentially by clamp 522 when used in operations.

In the embodiment in FIGS. 10-12, lip 545 is disposed on the inner jaw 529 and is pivotally mounted as part of swing arm 552 discussed previously. As such, swing arm 552 pivots lip 545 into and out of engagement with one of the opposite surfaces of the manway components.

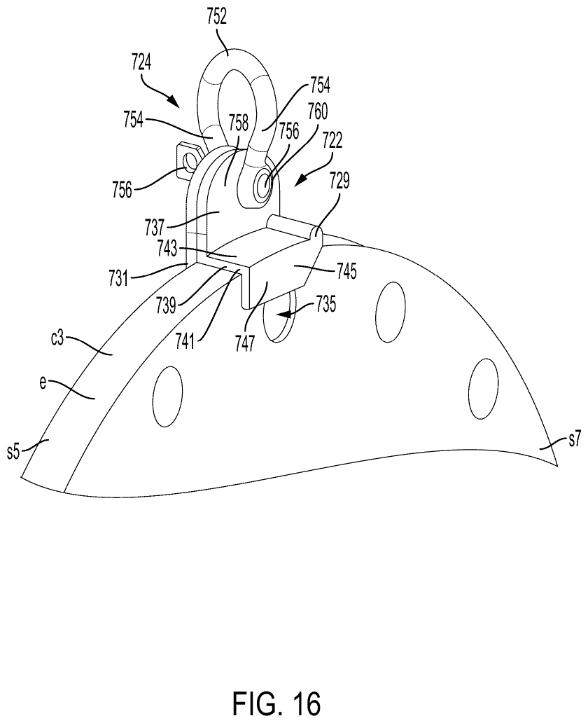

FIG. 16 illustrates another possible implementation of a clamping tool according to the present disclosure. In this implementation, clamping tool includes a clamp 722 which makes use of only a single one of the clamp fasteners 735. The more compact and portable nature of having only a single clamp fastener 735 makes clamp 722 potentially useful in more applications, especially those in which manway covers might need to be lifted from horizontal or other stored positions for a variety of operations or handling tasks. To that end, connector 724 on proximal end of clamping 722 is in the form of a U-shaped clip 752 having clip arms 754 and defining a clip opening between such arms. As such, clip arms 754 present attachment locations at which base portion 737 of clamp 735 may be secured. Base portions 737 is in the form of two plates 758 and extend between upper and lower plate ends. A clip pin 760 secures the upper plate ends together and inner and outer jaws 729, 731 are formed at the respective lower plate ends, such jaws being separated by a predetermined distance to receive circumferential edge e of a manhole component between such jaws.

Jaws 729, 731 are rotatable selectively about clip pin 760 so that clamp 722 may be removably secured to the manway component to be handled. Accordingly, inner jaw 729, with its corresponding features similar to previous embodiments, functions as a spring swing arm and is rotatable into and out of engagement with opposing surfaces, such as s7 according to the illustrated embodiment. Similar to previous embodiments, the swing arm formed by inner jaw 729 makes use of a lip 745 which extends in an opposing relationship to planar surface s7 on the manhole component. Also similar to previous embodiments, the swing arm of inner jaw 729 has a transverse jaw surface 739 which engages with edge e, such jaw surface having an arcuate portion 741 extending over an arcuate jaw portion link 743 to suitably resist bending moments.

Clip pin 760 may be suitably tightened to its attachment location 756 on the arms of U-shaped clip 752 to secure the clamp 722 relative to the manway component. The foregoing features allow the clamp 722 to be selectively attached and detached and substantially prevent it from disengaging from such manway component irrespective of orientation of the manway component relative to gravity, meaning the clamp 722 may remain engaged even if the manway component is horizontal, such as being lifted from the ground or other horizontal position.

Returning now to the implementation illustrated in FIGS. 9-12, clamping tool 521 includes a locking mechanism 560 which is selectively operable to retain lip 545 in a selected one of the first and second positions. Locking mechanism 560 makes use of a swing arm slot 564 defined in the outer jaw 531 of clamp 522. Swing arm slot 564 has a slot length and a guide pin 566 extending through swing arm slot 564. Guide pin 566 is sized to be movable within swing arm slot 564 along the slot length thereof.

Guide pin 566 has distal and proximal ends, the distal end of which is connected to the engaging portion 520 of lip 545, whereas the proximal end of the guide pin is threadably connected through the outer jaw to a first locking knob 568 accessible to the user. This first locking knob 568 may be operated, such as by tightening it during threadable engagement with corresponding threads, to fix the guide pin 566 relative to the swing arm slot 564 and thereby retain the swing arm 552 in a selected position, such as one in which the swing arm engages with one of the surfaces of the manway component to be handled.

Locking mechanism 560 may also include a component which acts upon pivot pin 562 about which swing arm 552 rotates. To that end, a pivot pin 562 extends through the pivot point of swing arm 552 and extends proximally through the outer jaw 531 to terminate at the proximal pivot point end. A second locking knob 570 and associated locking connection, such as threads, allow the second locking knob 570 to be advanced distally to engage an opposing surface of outer jaw 531 and thereby further resist unintended motion or pivoting of swing arm 552 relative to pivot pin 562.

Clamp 522 in the embodiment illustrated in FIGS. 9-12 may include still other features to aid in securement of the clamp to a corresponding one of manway components. For example, one of the jaws 529, 531 may have at least one radial slot 572 defined therein. Radial slot 572 extends over a slot length between minimum and maximum end locations and thus defines multiple radial locations relative to circumferential edge c3, so that spacing between clamp fasteners 535 may be adjusted to match an intended manway surface. To that end, in the illustrated embodiment, at least one radial slot is formed in the outer jaw 531, and a corresponding clamp fasteners 535 is adjustably securable relative to the slot and slidable radially therein. As such, the radial distance between adjacent clamp fasteners 535, in this case, the two fasteners as illustrated, can be adjusted. Suitable threaded connections, with handles as shown, allow the clamp fasteners 535 to be secured at the selected locations.

As such, this adjustment feature of clamp fasteners 535 permits clamp 522 to be used and securable to manway components with a variety of spacing between adjacent holes in such components. The range of spacing between holes h in manway components, which clamp 522 may accommodate is between the minimum and maximum end points of the one or more slots 572 which are disposed on one of the jaws of clamp 522. In the illustrated embodiment, clamp 522 has two radial slots 572 with each of the two clamp fasteners 535 slidably securable relative to a corresponding one of the radial slots 572.

Still further securement features may be proved to clamping tools hereunder, including those illustrated for clamp 522. To that end, clamp fasteners 535, as received in radial slots 572, are associated with a linkage 578 which provides certain advantageous securement features to clamp 522. Linkage 578 is configured so that, in response to adjustment of the radial location of one of the fasteners 535, the radial location of the other of the fasteners is adjusted as well. In the illustrated implementation, force applied to linkage 578, which moves one of the fasteners outwardly or inwardly likewise induces the corresponding force outwardly or inwardly on the other of the fasteners. As a result, linkage 578 can transmit force, such as manual force applied by pulling on lever arm 588, to urge clamp fasteners 535 against opposing wall portions of holes h, thereby providing additional securing force between clamp 522 and the manway component to which it is secured or being secured.

In the exemplary implementation, linkage 578 comprises a central link 580 rotatably mounted about a link pin 582, and also includes two fastener links 584. The central link 580 has two link arms 586 extending radially from link pin 582. The two fastener links 584 have respective fastener link ends rotatably connected to respective ones of the central link arms 586. The connection of fastener link ends is at a location which is radially spaced from the central link pin 582. The aforementioned lever arm 588 is operatively connected relative to central link 580, in this case integral therewith as shown, such that rotation of central link 580 caused by manual actuation of lever arm 588 applies force to clamp fasteners 535 either inwardly directed or outwardly directed relative to the holes h in which clamp fasteners 535 have been received, thus increasing engagement force on opposing portions of such holes and further securing clamp 522 relative thereto.

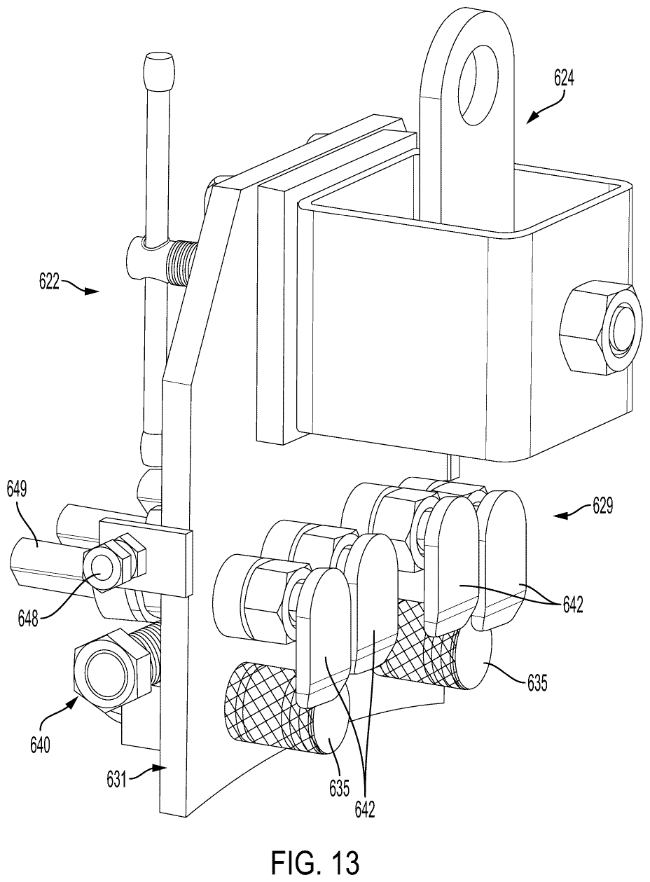

FIGS. 13-15 illustrate another possible implementation of the clamping tool according to the present disclosure. Clamp 622 has a jack bolt assembly 640 disposed on at least one of the opposing jaws locations radially inward from the circumference c. Jack bolt assembly 640 has features for receiving clamp fasteners 635 therethrough so as to secure its corresponding jaw to a manway component to be handled. In the illustrated implementation, jack bolt assembly 640 is formed on the proximal or outer side of outer jaw 631.

Jack bolt assembly 640 includes features that permit clamp fasteners 635 to be radially adjustable in a manner similar to that discussed previously with reference to clamp 522. To that end, jack bolt assembly 640 includes a pair of receiving apertures 644 formed in respective blocks at spaced locations from each other. The blocks are translatable relative to each other by a bolt assembly 661 to adjust the separation between the receiving apertures 644 over a range of different distances. Clamp fasteners 635 are mounted in radial slots similarly to as discussed with reference to clamp 522, but are also connected to the receiving apertures 644. In this manner, jack bolt assembly 640 may be operated to change the location of the receiving apertures 644 and thereby change the radial spacing of clamp fasteners 635 to correspond to a corresponding range of radial spacings of holes h in surfaces of manway components to which clamp 622 is to be attached.

Inner jaw 629 has formed thereon a plurality of rotatable fingers 642 which function in a manner similar to swing arm 552 of the previous embodiments. Fingers 642 may be selectively rotatable from a position out of engagement with circumferential edge e and then into engagement against opposing portions of the manway surface to be engaged, adjacent to circumferential edge e to thereby secure clamp 622 thereto. Detachment of clamp 622 reverses the foregoing steps. Rotatable fingers 642 of inner jaw 629 are located an operative distance from outer jaw 631, such distance corresponding to at least the thickness of edge e. Finger 642 are thus pivotally secured at locations radially outwardly from edge e of circumference c3 when clamp fasteners 635 are received in corresponding holes h. Fingers 642 may assume a variety of shapes and sizes other than those in the illustrated embodiment and are sized to engage opposing portions of whatever opposite surface s1, s3, s5, s7 opposes fingers 642.

Rotatable fingers 642 have suitable mechanisms associated therewith to accomplish desired rotations into and out of engagement with manway components. In the illustrated embodiment, there are two sets of two rotatable fingers 642 and a connecting rod 648 between the two sets of fingers. Connecting rod 648 may be movable by any number of means in a translational direction and through linkages as shown to induce rotation of corresponding sets of the fingers. Rotatable finger 642 may likewise be connected to heads 649, which heads 649 are shaped to be operated upon by a tool or mechanism to rotate such heads. By means of connecting rod 648 or heads 649, translation or rotation is translated into rotation of at least one of the clamp fasteners 635.

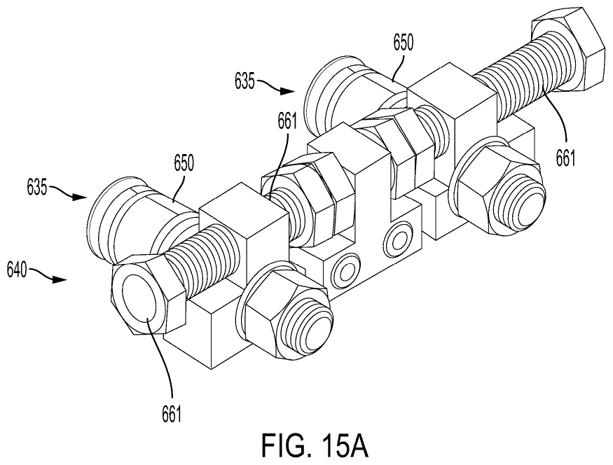

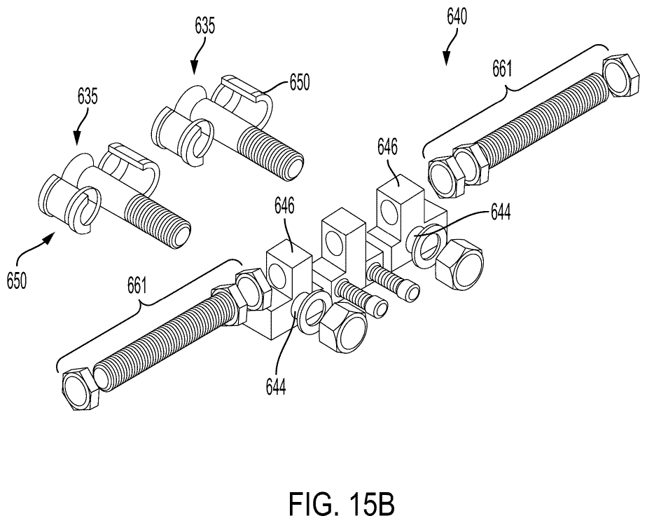

Clamp fasteners 635, as in previous embodiments, may have a variety of surface configurations, treatments or shapes. In the case of clamp 622, claim fasteners 635 have an eccentric or expandable profile as shown by collars 650 (FIG. 15B), and are therefore rotatable during insertion into corresponding one of the holes h to form an interference fit with opposing portions of hole h into which the clamp fastener has been received.

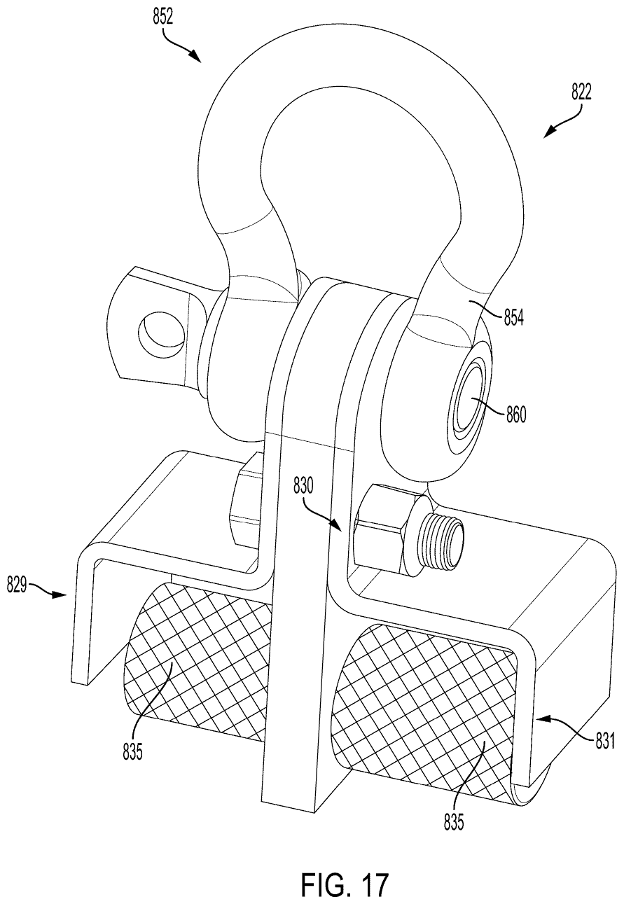

FIG. 17 shows still another possible implementation of a clamping tool according to the present invention, comprising a clamp 822 with three opposing jaws. In this case, a central jaw 830 is flanked by two outer jaws 829, 831, each spaced from central jaw 830 to correspond to the thickness of an edge e of a manhole component. Two clamp fasteners 835 are fastened to central jaw 830 and extend from opposite sides of such central jaw 830 toward the respective outer jaws 829, 831.

Similar to the embodiment of FIG. 16, outer jaws 829, 831 are selectively rotatable relative to central jaw 830 about a pin 860. Pin 860, in turn, provides attachment points for a U-shaped clip 854. Jack bolt is used to secure the three jaws relative to each other. Clamp 852 may receive a hole h of a manway component on either of the clamping fasteners 835. Accordingly, the appropriate one of outer jaw 829, 831 may be selectively rotated after the clamping fastener 835 has been received into the hole h, and the appropriate outer jaw 829, 831 thereby opposes the corresponding one of opposite sides s1, s3, s5, or s7, as the case may be, to engage clamp 852 with the manway component. The flexibility of engaging clamp 852 of either side of central jaw 830 is useful in certain manway component handling operations.

It will be further understood that still further changes and variations in the details, materials, and arrangements of the components, parts, and features which have been described and illustrated may be made. All such modifications are deemed to be within the scope of this disclosure, as defined by the appended claims.

What is claimed is:

1. A clamping tool for use in handling operations related to a manway, in which the manway has manway components including a manway flange and a manway cover associated therewith, in which the manway cover and the manway flange each have a circumferential edge with an associated thickness and each having a pair of opposite surfaces extending radially inwardly from each of the edges to define the manway flange and the manway cover, respectively, and in which the manway flange and the manway cover are secured to each other by a plurality of manway cover fasteners received through corresponding, circumferentially spaced holes of a predetermined size, the holes passing through the manway flange and the manway cover at predetermined, radially spaced hole locations about the circumferences, the clamping tool comprising:
a clamp having proximal and distal portions, the proximal portion having a connector disposed thereon for contemplated handling operations, the distal portion configured to be removably securable to either one of the pairs of opposite surfaces of the manway flange or the manway cover;
wherein the proximal portion of the clamp includes a base portion, wherein the distal portion of the clamp includes a pair of opposing jaws connected to and extending from the base portion, and at least one clamp fastener extending from one of the jaws toward the other of the jaws;
wherein the pair of jaws are adapted to be adjustable to be selectively secured to or removed from the opposite surfaces;
wherein the clamp fastener is oriented to extend between the jaws and is configured to be insertable into a corresponding one of the holes of predetermined size;
wherein, when the clamp is secured to the opposite surfaces, the base portion is positioned at a location radially outwardly from the corresponding circumference; and the jaws and the clamp fastener are positioned at locations radially inwardly from the corresponding circumference.

2. The clamping tool of claim 1, wherein the clamp fastener is selected from the group consisting of unthreaded pins, threaded pins, threadably received bolts, and threaded through-bolt-and-nut assemblies.

3. The clamping tool of claim 1, further comprising two of the clamp fasteners located and arcuately spaced to engage two of the predetermined-sized holes.

4. The clamping tool of claim 1 further comprising three of the clamp fasteners located and arcuately spaced to engage three of the predetermined-sized holes.

5. The clamping tool of claim 1, wherein one of the jaws of the clamp includes a transverse, jaw surface configured to oppose and engage an opposing portion of the circumferential edge when the clamp is secured thereto.

6. The clamping tool of claim 5, in which the circumference is selected from the group consisting of circular and ovoid and thereby define an arcuate portion on the circumferential edge, wherein the transverse jaw surface comprises an arcuate jaw portion having an arc-length configured to oppose the arcuate portion along the arc-length.

7. The clamping tool of claim 6, wherein one of the jaws includes a lip extending over a corresponding lip arc-length, the lip extending radially inwardly from the circumferential edge when the clamp is secured thereto, the lip having engaging portions configured to extend and engage an opposing one of the opposite surfaces over the lip arc-length to resist bending moments acting on the clamping tool.

8. The clamping tool of claim 7, wherein the lip is disposed on the inner jaw and is pivotally mounted thereto at a radial location along the lip arc-length to selectively pivot the engaging portions of the lip to form a swing arm the swing arm pivotable to a first position corresponding to the engagement of a corresponding one of the opposite surfaces and a second position located radially outwardly from the first position sufficiently to permit disengagement of the inner jaw from the corresponding one of the opposite surfaces.

9. The clamping tool of claim 8, comprising:
no more than one of the clamp fasteners; and
wherein the connector comprises a U-shaped clip having arms defining a clamp opening between the arms, the arms having respective, attachment locations thereon; and
wherein the base portion of the clamp comprises respective plates selectively securable to each other and extending between upper and lower plate ends, the upper plate ends extending radially outwardly from the circumferences when the clamping tool is secured thereto; the lower plate ends extending radially inwardly when the clamping tool is secured thereto;
wherein the upper plate ends are sized to be positionable in the clamp opening and having inner surfaces opposing each other and alignable apertures defining a through-hole when the plates are positioned between the clamp arms, the through-hole extending orthogonally to the plates when positioned;
wherein the jaws of the clamp are disposed at the lower plate ends and, when the upper plate ends are positioned between the arms, the jaws are spaced from each other by a distance corresponding to the thickness of the corresponding circumferential edge;
the clamping tool further comprising a clip pin sized to be selectively securable to the attachment locations of the U-shaped clip and selectively insertable through the through-hole, the clip pin adapted to secure the plates to be selectively rotatable and securable relative to each other to open and close the clamping tool to selectively attach and detach the clamping tool to the corresponding circumferential edge;
wherein the clip pin, when received through the through-hole and secured to the plates, prevents the clamping tool from disengaging when secured to the circumferential edge, irrespective of the orientation of the clamping tool relative to the circumferential edge.

10. The clamping tool of claim 8,
wherein the clamp has a longitudinal axis and a pair of transverse, clamp sides at respective locations spaced from the longitudinal axis, the clamp comprising two of the clamp fasteners proximate to respective transverse clamp sides and mounted at spaced, transverse locations corresponding to adjacent ones of the circumferentially spaced holes; and
wherein the lip is pivotably mounted at a first location proximate to one of the clamp fasteners and extending to a second location in operative proximity to the other one of the clamp fasteners, whereby the lip is selectively rotatable circumferentially outwardly from the circumferential edge of the corresponding opposite surface.

11. The clamping tool of claim 10, wherein the clamp comprises a locking mechanism selectively operable to retain the lip in a selective one of the first and second positions.

12. The clamping tool of claim 11, wherein the locking mechanism comprises a swing arm slot defined in the outer jaw, the swing arm slot having a slot length and a guide pin extending through the swing arm slot, the guide pin sized to be movable within the swing arm slot over the slot length, the guide pin having distal and proximal ends, the distal end connected to the engaging portion of the swing arm and the proximal end threadably connected to a first locking knob, wherein the locking knob is adapted to be operable to fix the pin relative to the swing arm slot and thereby retain the swing arm in a selected position.

13. The clamping tool of claim 12, wherein the locking mechanism further comprises a pivot pin having a distal pivot pin end connected to the location about which the swing arm pivots, the pivot pin extending proximally through the outer jaw to terminate in a proximal pivot pin end, the clamp having a second locking knob disposed at the proximal pivot pin end and adapted to be advanceable distally along the pivot pin to engage an opposing surface of the outer jaw to resist pivoting of the swing arm relative to the pivot pin.

14. The clamping tool of claim 10,
wherein one of the jaws has portions defining at least one slot, the slot extending over a slot length between minimum and maximum end locations to define multiple radial locations along the circumferential edge; and
wherein a corresponding one of the clamp fastener is securable relative to the slot at a selected one of the radial locations to adjust the radial distance between the two fasteners to be receivable into adjacent ones of the holes, the adjustable radial distance between the clamp fasteners adapted to permit the clamp to be securable to opposite surfaces having holes separated by different radial distances ranging between the minimum and maximum end points of the slot length.

15. The clamping tool of claim 14, comprising two of the slots, each of the two clamp fasteners slidably secured relative to a corresponding one of the slots.

16. The clamping tool of claim 15, wherein each of the jaws has a corresponding inner face positionable to oppose respective ones of the opposite surfaces, wherein the clamp fasteners are secured to one of the inner faces by respective, threaded connections extending through the slot, the threaded connections tightenable to secure the clamp fasteners in a selected one of the radial locations of the respective slots.

17. The clamping tool of claim 16, further comprising a linkage connecting the two clamp fasteners, the linkage configured so that, in response to adjustment of the radial location of one of the fasteners, the radial location of the other of the fasteners is adjusted.

18. The clamping tool of claim 17, wherein the linkage comprises a central link rotatably mounted about a link pin between the two clamp fasteners and two fastener links, the central link having two link arms extending radially from the link pin, the fastener links having respective fastener link ends rotatably connected to respective ones of the central link arms at link connection locations radially spaced from the link pin, the linkage further comprising at least one lever arm operatively connected relative to the central link to urge the clamp fasteners into an interference fit against the ends of the respective slots in which the clamp fasteners are slidably received, whereby the clamp is further secured relative to the corresponding opposite surface.

19. The clamping tool of claim 10, further comprising
a jack bolt assembly disposed on at least one of the opposing jaws at a location radially inwards from the circumference and in operative proximity to corresponding ones of the holes to be engageable therewith;
the other one of the jaws comprising a plurality of rotatable fingers;
wherein the jack bolt assembly includes a pair of receiving apertures formed in respective blocks at spaced locations from each other, the blocks being translatable relative to each other to adjust the separation between the apertures over a range of distances, the clamp fasteners receivable through the apertures, whereby the clamp fasteners are adjustable to a selected radial distance from each other corresponding to the radial spacing of opposing ones of the holes in the opposite surfaces;
wherein the rotatable fingers of the second of the jaws are located an operative distance from the first one of the jaws, the distance corresponding to at least the thickness of the edge, the fingers pivotally secured at locations radially outwardly from the edge of the circumference when the clamp fasteners are received in the holes, the rotatable fingers sized to engage opposing portions of the opposite surface when rotated toward the opposite surface.

20. The clamping tool of claim 19, comprising two sets of the two rotatable fingers and a connecting rod between the two sets of fingers, the connecting rod adjustable to selectively rotate at least one of the two sets of fingers.

21. The clamping tool of claim 20, wherein the clamp fasteners have an eccentric profile, and wherein the claim fasteners are mounted to the jaw to be rotatable after insertion into a corresponding one of the holes, whereby the eccentric profile forms an interference fit with opposite portions of the hole into which the clamp fastener has been received.

22. The clamping tool of claim 1, further comprising;
three of the opposing jaws, the three jaws including a central jaw having opposite sides and two outer jaws, one on each of the opposite sides of the central jaw, the outer jaws having jaw surfaces facing respective opposite sides of the inner jaw at distances corresponding to the thickness of the circumferential edges; and
two of the clamp fasteners, one fastener extending from each of the opposite sides of the central jaw toward respective outer jaws;
wherein the outer jaws are selectively rotatable relative to the central jaw to receive the circumferential edge between a selected one of the outer jaws and the central jaw for attaching to and handling in four positions relative to the circumferential edges.

23. The clamping tool of claim 1, further comprising a davit assembly having a davit base and a davit arm, and wherein the connector is adapted to connect the clamp to either one of the base and the arm.

24. A clamping tool for use in handling operations related to a manway, in which the manway has manway components including a manway flange and a manway cover associated therewith, in which the manway cover and the manway flange each have a circumferential edge with an associated thickness and each having a pair of opposite surfaces extending radially inwardly from each of the edges to define the manway flange and the manway cover, respectively, and in which the manway flange and the manway cover are secured to each other by a plurality of manway cover fasteners received through corresponding, circumferentially spaced holes of a predetermined size, the holes passing through the manway flange and the manway cover at predetermined, radially spaced hole locations about the circumferences, the clamping tool comprising:
a clamp having proximal and distal portions, the proximal portion having a connector disposed thereon for contemplated handling operations, the distal portion configured to be removably securable to either one of the pairs of opposite surfaces of the manway flange or the manway cover;
wherein the proximal portion of the clamp includes a base portion, wherein the distal portion of the clamp includes a pair of opposing jaws connected to and extending from the base portion, and at least two clamp fastener extending from one of the jaws toward the other of the jaws;
wherein the pair of jaws are adapted to be adjustable to be selectively secured to or removed from the opposite surfaces;
wherein the clamp fasteners are oriented to extend between the jaws and are configured to be insertable into corresponding ones of the holes of predetermined size;
wherein, when the clamp is secured to the opposite surfaces, the base portion is positioned at a location radially outwardly from the corresponding circumference; and the jaws and the clamp fasteners are positioned at locations radially inwardly from the corresponding circumference;
wherein the inner jaw comprises a swing arm with an engaging portion, the swing arm pivotably mounted at the distal portion of the clamp and pivotable between first and second positions, the first position corresponding to engagement by the engaging portion of a corresponding one of the opposite surfaces of the manway components, the second position located radially outwardly from the first position sufficiently to permit disengagement of the inner jaw from the corresponding one of the opposite surfaces of the manway component;
wherein the clamp comprises a locking mechanism selectively operable to retain the swing arm in a selected one of the first and second positions, the locking mechanism including a swing arm slot defined in the outer jaw, the swing arm slot having a slot length and a guide pin extending through the swing arm slot, the guide pin sized to be movable within the swing arm slot over the slot length, the guide pin having distal and proximal ends, the distal end connected to the engaging portion of the swing arm and the proximal end threadably connected to a locking knob; and
wherein locking knob is adapted to be operable to fix the guide pin relative to the swing arm slot and thereby retain the swing arm in a selected one of the positions.

25. A clamping tool for use in handling operations related to a manway, in which the manway has manway components including a manway flange and a manway cover associated therewith, in which the manway cover and the manway flange each have a circumferential edge with an associated thickness and each having a pair of opposite surfaces extending radially inwardly from each of the edges to define the manway flange and the manway cover, respectively, and in which the manway flange and the manway cover are secured to each other by a plurality of manway cover fasteners received through corresponding, circumferentially spaced holes of a predetermined size, the holes passing through the manway flange and the manway cover at predetermined, radially spaced hole locations about the circumferences, the clamping tool comprising:
a clamp having proximal and distal portions, the proximal portion having a connector disposed thereon for contemplated handling operations, the distal portion configured to be removably securable to either one of the pairs of opposite surfaces of the manway flange or the manway cover;
wherein the proximal portion of the clamp includes a base portion, wherein the distal portion of the clamp includes a pair of opposing jaws connected to and extending from the base portion, and at least two clamp fastener extending from one of the jaws toward the other of the jaws;
wherein the pair of jaws are adapted to be adjustable to be selectively secured to or removed from the opposite surfaces;
wherein the clamp fasteners are oriented to extend between the jaws and is configured to be insertable into a corresponding one of the holes of predetermined size;
wherein, when the clamp is secured to the opposite surfaces, the base portion is positioned at a location radially outwardly from the corresponding circumference; and the jaws and the clamp fastener are positioned at locations radially inwardly from the corresponding circumference;
wherein one of the jaws has portions defining at least one slot, the slot extending over a slot length between minimum and maximum end locations to define multiple radial locations along the circumferential edge; and
wherein a corresponding one of the clamp fastener is securable relative to the slot at a selected one of the radial locations to adjust the radial distance between the two fasteners to be receivable into adjacent ones of the holes, the adjustable radial distance between the clamp fasteners adapted to permit the clamp to be securable to opposite surfaces having holes separated by different radial distances ranging between the minimum and maximum end points of the slot length.
